(19) United States
(12) Patent Application Publication
(10) Pub. No.: US 2014/0035800 A1
(43) Pub. Date: Feb. 6, 2014

(54) SEGMENTED PARALLAX BARRIER BASED DISPLAY APPARATUS WITH 2D/3D MODE SWITCHING AND METHOD THEREOF

(71) Applicants: CNO Co., Ltd., Daegu (KR); Electronics and Telecommunications Research Institute, Daejeon-si (KR)

(72) Inventors: Hyun LEE, Daejeon-si (KR); Eung Don LEE, Daejeon-si (KR); Young Heuk CHO, Daegu (KR)

(73) Assignees: CNO Co., Ltd., Daegu (KR); Electronics and Telecommunications Research Institute, Daejeon-si (KR)

(21) Appl. No.: 13/959,352

(22) Filed: Aug. 5, 2013

(30) Foreign Application Priority Data
Aug. 6, 2012 (KR) 10-2012-0085724
Aug. 1, 2013 (KR) 10-2013-0091559

(51) Int. Cl. G09G 3/36

(52) U.S. Cl. CPC G09G 3/3614
USPC 345/96

(57) ABSTRACT

Disclosed are a segmented parallax barrier based display apparatus with 2D/3D mode switching and a method thereof. The parallax barrier based display apparatus may include a first panel reproducing an image; and a second panel positioned on a front surface of the first panel and including a first liquid crystal for forming a parallax barrier that blocks a part of the image reproduced by the first panel and a second liquid crystal for switching polarization of light that transmits the first liquid crystal.

This application claims the benefit of priority of Korean Patent Applications No. 10-2012-0085724 filed on Aug. 6, 2012 and No. 10-2013-0091559 filed on Aug. 1, 2013, which is incorporated by reference in its entirety herein.

### BACKGROUND OF THE INVENTION

1. Field of the Invention

Embodiments of the present invention relate to a parallax stereogram, and more particularly, to an autostereoscopic 3 dimension (3D) display apparatus that displaying a stereoscopic image by using a parallax barrier and a method thereof.

2. Discussion of the Related Art

A 3 dimension (3D) display type is largely divided into a glasses type in which a user needs to wear glasses at the time of viewing a stereoscopic image and an autostereoscopic type in which the user need not additionally wear the glasses. The glasses type may be divided into an anaglyph type, a polarized glasses type, and a shutter glasses type, and the autostereoscopic type may be divided into a lenticular type and a parallax barrier type.

Since the anaglyph type as a type that reproduces the stereoscopic image by using complementary colors of a red color and a blue color is simple in implementation principle, the anaglyph type has an advantage that complicated technology or high-priced equipment is not required, but a disadvantage that it is difficult to accurately express a color sense and vertigo is caused due to color separation.

The polarized glasses type as a type that divides scan lines of a display into even numbered lines and odd numbered lines, respectively and thereafter, simultaneously reproduces a left image and a right image through the respective scan lines has an advantage that is simple in structure of the glasses and is cheap, but a disadvantage that the resolution of the stereoscopic image is reduced.

The shutter glasses type as a type that alternately outputs the left image and the right image at high speed has an advantage that may minimize degradation of an image quality of the 3D image, but a disadvantage that an eye easily gets tired and the prices of the shutter glasses is expensive.

Meanwhile, a lenticular type in the autostereoscopic type as a type in which a lenticular lens is disposed in a display apparatus has an advantage that glasses need not be worn at the time of viewing the stereoscopic image, but a disadvantage that as a semicircular lens is disposed in the display apparatus, a wave pattern is viewed at the time of viewing the stereoscopic image and the display apparatus becomes expensive.

In contrast, the parallax barrier type as a type in which a parallax barrier is disposed in the display apparatus has an advantage that the glasses need not be worn at the time of viewing the stereoscopic image and a disadvantage that it is convenient to manufacture the display apparatus and the wave pattern is not viewed at the time of viewing the stereoscopic image unlike the lenticular type. However, a parallax barrier based autostereoscopic 3D display type is narrow in viewing angle due to the parallax barrier. Therefore, when a watching angle is changed, a 3D effect disappears, and as a result, there is an inconvenience that a watching position needs to be fixed.

As technology for solving the problem, for example, Korean Patent Unexamined Publication No. 10-2007-0023849 (Publication date: Mar. 2, 2007) “Stereoscopic Display Apparatus Having Wide Viewing Angle” discloses a segmented parallax barrier type that segments a barrier electrode into a plurality of minute barrier electrodes, and combines and drives the minute barrier electrodes depending on the position of a user to provide a wide viewing angle. However, in this method, when the display apparatus operates in a 3D mode, light is partially transmitted through a gap between the minute barrier electrodes, and as a result, crosstalk occurs. Therefore, 3D quality deteriorates, a flexible printed circuit (FPC) becomes expensive, and bonding becomes difficult.

Light leakage in which light is partially transmitted through the gap between the minute barrier electrodes, which is a disadvantage of the aforementioned segmented parallax barrier type can be prevented by appropriately arranging transparent electrodes in a twisted nematic (TN) liquid crystals of the parallax barrier, operating the TN liquid crystals in a normally black mode which is a type in which light is transmitted when voltage having a predetermined intensity is applied to the transparent electrodes, and applying voltage to only transparent electrodes at positions to be transmitted with light. However, in this method, since the TN liquid crystal operates in the normally black mode, the voltage needs to be applied to all of the transparent electrodes of the parallax barrier when the display apparatus operates in a 2D mode. Accordingly, power consumption of the display apparatus increases. Further, there is a problem that light is blocked at a minute gap between the barrier electrodes to which the voltage cannot be applied, and as a result, a vertical stripe is viewed.

### SUMMARY OF THE INVENTION

An object of the present invention is to provide a segmented parallax barrier based display apparatus with 2D/3D mode switching and a method thereof that can solve a problem in which a light leakage phenomenon occurs when a display apparatus operates in a 3D mode or a vertical stripe is viewed when the display apparatus operates in a 2D mode.

Another object of the present invention is to provide a segmented parallax barrier based display apparatus with 2D/3D mode switching and a method thereof that can reduce power consumption of a display apparatus.

In accordance with an embodiment of the present invention, a parallax barrier based display apparatus includes a first panel reproducing an image; and a second panel positioned on a front surface of the first panel and including a first liquid crystal for forming a parallax barrier that blocks a part of the image reproduced by the first panel and a second liquid crystal for switching polarization of light that transmits the first liquid crystal.

The first liquid crystal and the second liquid crystal may operate in a normally white mode to transmit light when voltage is not applied and block light when voltage is applied.

The first panel may include a backlight irradiating light; a first polarizer polarizing the light irradiated from the backlight; a liquid crystal transmitting the light polarized by the first polarizer; and a second polarizer polarizing the light transmitting the liquid crystal.

The second panel further may include a third polarizer polarizing the light transmitting the second liquid crystal in the same direction as the second polarizer.

The second panel may further include a pair of first transparent electrodes arranged on a front surface and a rear surface of the first liquid crystal based on the first liquid crystal to obliquely deviate from each other in a symmetric pattern to apply driving voltage to the first liquid crystal; and a pair of second transparent electrodes arranged on a front surface and a rear surface of the second liquid crystal based on the second liquid crystal to apply the driving voltage to the second liquid crystal.

The first transparent electrodes may include a plurality of patterned indium tin oxides (ITOs) that is separated into at least two groups, and the second transparent electrode is a plate-like ITO.

The parallax barrier based display apparatus may further include a driving unit applying the driving voltage to the second panel in accordance with the position of a user and a watching distance.

In accordance with another embodiment of the present invention, a display panel includes: a first liquid crystal for forming a parallax barrier that blocks a part of an image reproduced by a panel reproducing an image; and a second liquid crystal for switching polarization of light that transmits the first liquid crystal.

In accordance with yet another embodiment of the present invention, a method of displaying an image in a parallax barrier based display apparatus includes: reproducing the image through a first panel; and applying driving voltage to a second panel positioned on a front surface of the first panel when the display apparatus operates in a 3D mode, and the second panel includes a first liquid crystal for forming a parallax barrier that blocks a part of the image reproduced by the first panel and a second liquid crystal for switching polarization of light that transmits the first liquid crystal.

### BRIEF DESCRIPTION OF THE DRAWINGS

FIG. 1 is a diagram illustrating a symmetric segmented parallax barrier based display apparatus.

FIG. 2 is an exemplary diagram illustrating a state of a parallax barrier in a 2D mode and a 3D mode when a TN liquid crystal operates in a normally white mode in the symmetric segmented parallax barrier based display apparatus.

FIG. 3 is an exemplary diagram illustrating a state of the parallax barrier in the 2D/3D mode when the TN liquid crystal operates in a normally black mode in the symmetric segmented parallax barrier based display apparatus.

FIG. 4 is a diagram illustrating a structure of a segmented parallax barrier based display apparatus with 2D/3D mode switching according to an embodiment of the present invention.

FIG. 5 is a diagram illustrating 2D mode and 3D mode operating ways of the parallax barrier based display apparatus according to the present invention.

FIG. 6 is a flowchart illustrating a segmented parallax barrier based display method with 2D/3D mode switching according to an embodiment of the present invention.

### DETAILED DESCRIPTION OF THE EMBODIMENTS

Hereinafter, embodiments of the present invention are described in detail with reference to the accompanying drawings. In describing the embodiments of the present invention, a detailed description of related known elements or functions will be omitted if it is deemed to make the gist of the present invention unnecessarily vague.

In this specification, when it is said that one element is ‘connected’ or ‘coupled’ with the other element, it may mean that the one element may be directly connected or coupled with the other element and a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Hereinafter, embodiments of the present invention will be described in detail with reference to the accompanying drawings such that those skilled in the art can easily implement the embodiments. However, the present invention may be implemented in various different forms and the present invention is not limited to embodiments described below. In addition, parts which are not associated with the description are not illustrated in the drawings in order to clearly describe the present invention and like reference numerals refer to like elements throughout the specification.

Throughout the specification, when a predetermined part “includes” a predetermined component, it is understood that if it is not contrarily described, the part may further include other components and not exclude the other components. Further, terms such as “unit” disclosed in the specification mean units that processes at least one function or operation and can be implemented by hardware or software, or a combination of the hardware and the software.

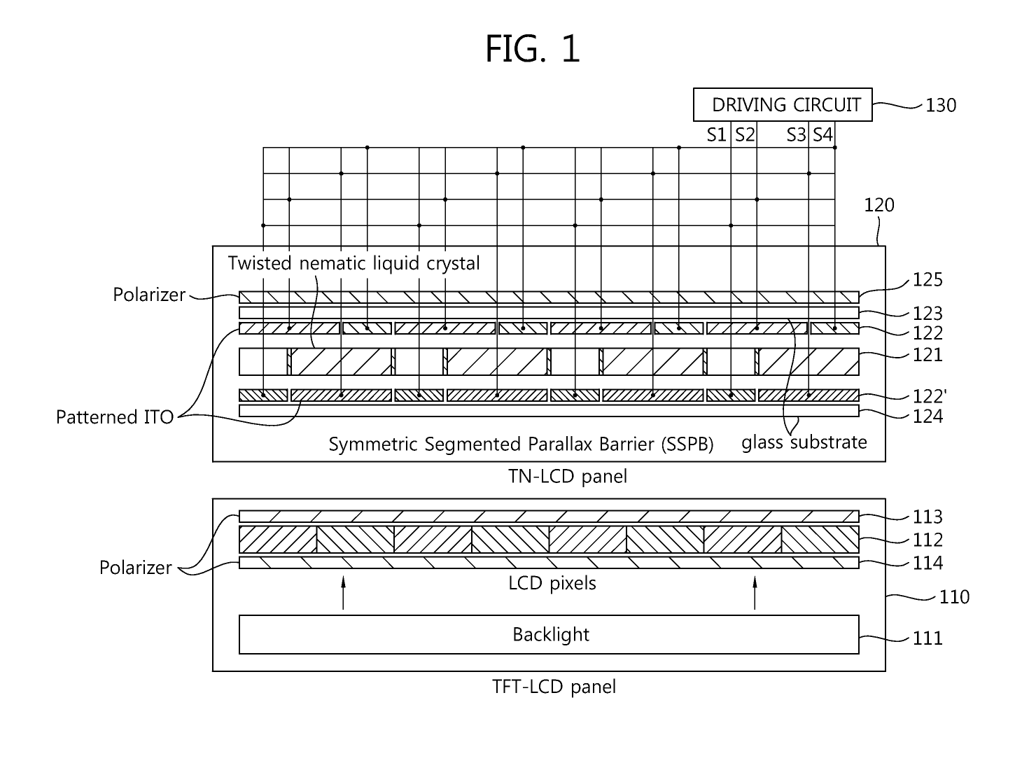

FIG. 1 is a diagram illustrating a symmetric segmented parallax barrier based display apparatus.

First, referring to FIG. 1, a symmetric segmented parallax barrier (SSPB) type autostereoscopic 3D display apparatus includes a thin film transistor-liquid crystal display panel (TFT-LCD) 110, a twisted nematic-LCD (TN-LCD) panel 120, and a driving circuit 130.

The TFT-LCD panel 110 as a panel for reproducing an image by the unit of a pixel generally includes a backlight 111 irradiating light, a TFT liquid crystal 112 reproducing LCD pixels by transmitting the light irradiated from the backlight 111, and two polarizers 113 and 114 vertically or horizontally polarizing the light irradiated from the backlight 110, as illustrated in FIG. 1.

The TN-LCD panel 120 includes a TN liquid crystal 121, a pair of transparent electrodes (indium tin oxide, ITO) 122 and 122′, glass substrates 123 and 124, and a polarizer 125 to operate as a symmetric segmented parallax barrier. In this case, the pair of transparent electrodes 122 and 122′may be constituted by a plurality of patterned ITOs as illustrated in FIG. 1.

When the TN-LCD panel 120 is applied with driving voltage from the driving circuit 130, light emitted from the TFT-LCD panel 110 is separate to be transmitted by each of left and right eyes of a user. When the image is actually reproduced, the light emitted from the TFT-LCD panel 110 is blocked or transmitted by the TN liquid crystal 121 provided between the glass substrates 123 and 124. The TN liquid crystal 121 may be divided into a case in which the TN liquid crystal 121 operates in a normally black mode which is a type (in contrast, light is blocked when voltage is not applied) in which light is transmitted when voltage having a predetermined intensity is applied to each of the transparent electrodes 122 and 122′ and a case in which the TN liquid crystal 121 operates in a normally white mode which is a type (in contrast, light is blocked when the voltage is applied) in which light is transmitted when voltage is not applied). In FIG. 1, for example, an area where the liquid crystal is transmitted with light is marked by a white color and an area to block light is marked with an oblique line.

The driving circuit 130 as a circuit for providing driving voltage to the TN-LCD panel 120 is connected with each of the transparent electrodes 122 and 122′ by several electrodes S1 to S4.

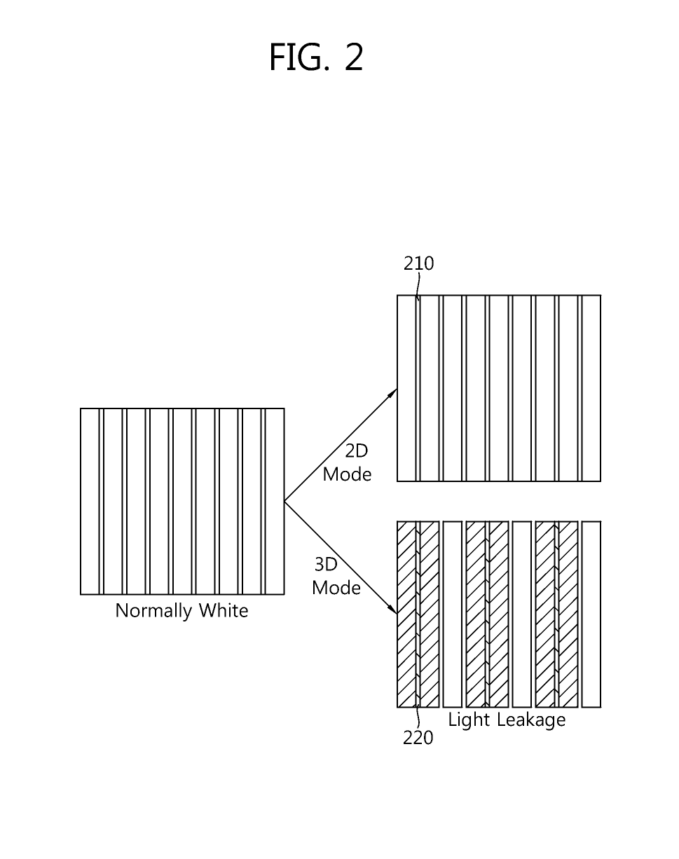

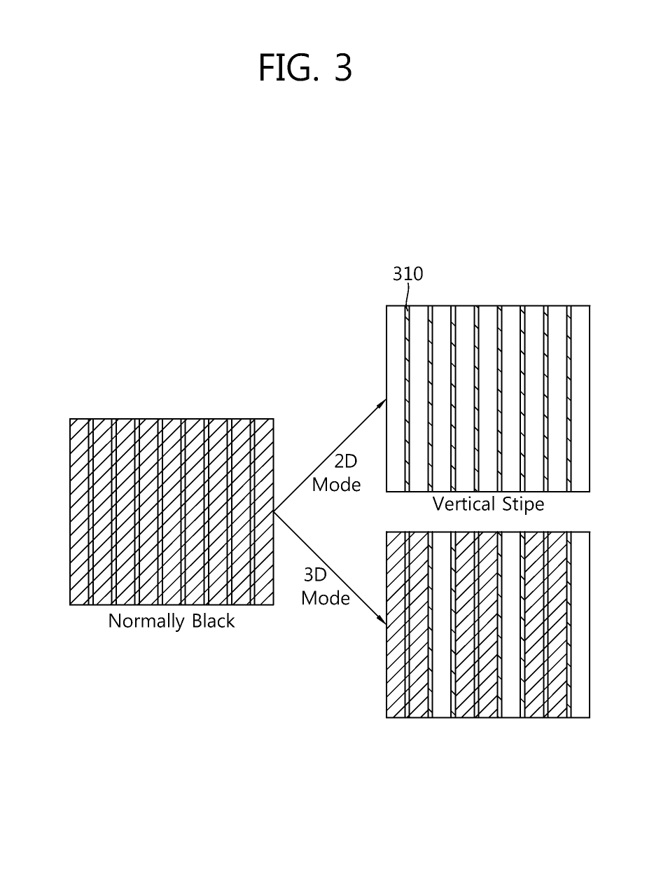

FIG. 2 is an exemplary diagram illustrating a state of a parallax barrier in a 2D mode and a 3D mode when a TN liquid crystal operates in a normally white mode in the symmetric segmented parallax barrier based display apparatus. FIG. 3 is an exemplary diagram illustrating a state of the parallax barrier in the 2D/3D mode when the TN liquid crystal operates in a normally black mode.

First, referring to FIG. 2, when the TN liquid crystal operates in the normally black mode, light is normally transmitted through each minute gap 210 between barriers in the 2D mode (a mode in which a 2D image is reproduced). However, in the 3D mode (a mode in which a stereoscopic image is reproduced), a phenomenon in which light leaks through a minute gap 220 to which voltage that exists between barriers applied with voltage is not applied occurs. Meanwhile, as illustrated in FIG. 3, when the TN liquid crystal operates in the normally black mode, the barrier is removed by applying voltage to only barrier electrodes at positions to be transmitted with light in the 3D mode to prevent the light leakage phenomenon from occurring, but since light needs to be transmitted through an entire area of the 3D panel by applying voltage to all of the barrier electrodes in the 2D mode, power consumption increases and light is blocked through a minute gap 310 between the barrier electrodes to which voltage is not applied, and as a result, a vertical stripe is viewed.

As such, in the segmented parallax barrier based display apparatus, when the TN liquid crystal operates in the normally white mode, the light leakage phenomenon occurs in the 3D mode and when the TN liquid crystal operates in the normally black mode, the power consumption increases and the vertical stripe occurs in the 2D mode.

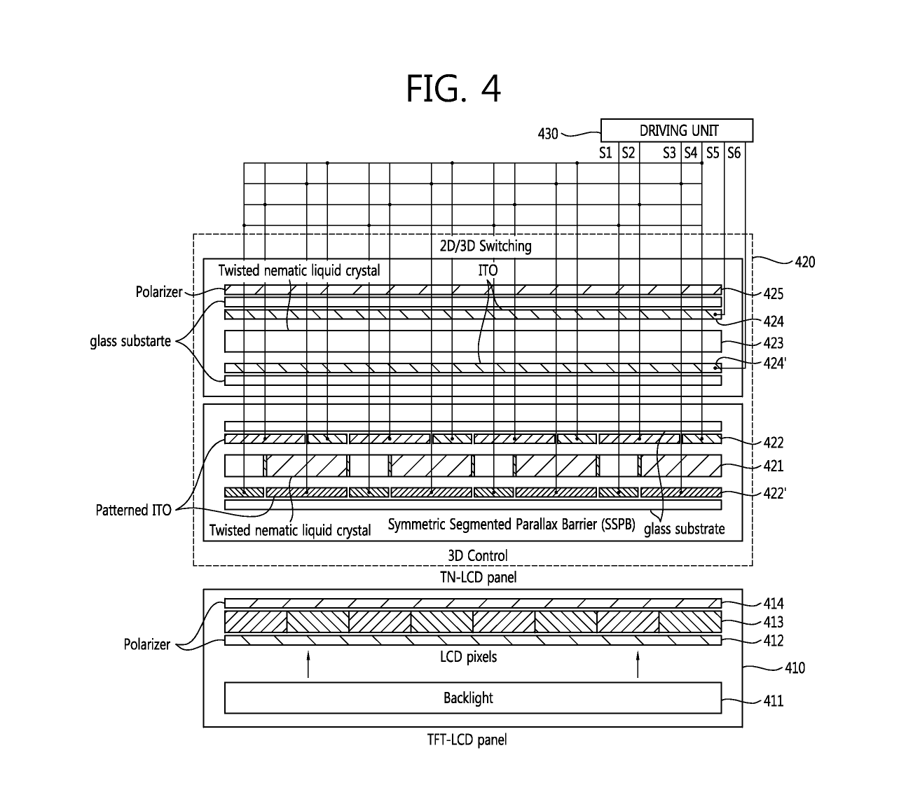

FIG. 4 is a diagram illustrating a structure of a segmented parallax barrier based display apparatus with 2D/3D mode switching according to an embodiment of the present invention.

The segmented parallax barrier based display apparatus with 2D/3D mode switching according to the present invention may include a first panel 410, a second panel 420, and a driving unit 430.

The first panel 410 as a panel that reproduces the 2D or 3D image may be, for example, a TF-LCD panel that includes a backlight 411 irradiating light, a first polarizer 412 polarizing the light irradiated from the backlight 411, a liquid crystal 413 displaying LCD pixels by transmitting the light polarized through the first polarizer 412, and a second polarizer 414 polarizing the light that transmits the liquid crystal 413 as illustrated in FIG. 4. The first panel 410 may be implemented by various display panels such as a light emitting diode display (LED) panel, an organic light emitting diode display (OLED) panel, a plasma display panel (PDP), an electroluminescent (EL) display panel, and the like, in addition to the LCD panel. When the first panel 410 reproduces the 3D image, the first panel 410 may alternately display a left image and a right image by the unit of a column so as to reproduce the left eye and the right image of the 3D image simultaneously.

When the image reproduced by the first panel 410 is the 3D image, the second panel 420 is positioned on a front surface of the first panel 410 to operate as a 3D panel that allows the 3D image to be stereoscopically viewed. To this end, the second panel 420 may include a first liquid crystal 421 for forming the parallax barrier that blocks a part of the image reproduced by the first panel 410 and a second liquid crystal 423 for switching polarization of light that transmits the first liquid crystal 421 at 90° when the display apparatus operates in the 2D mode.

As one example, the first liquid crystal 421 may be positioned in a pair of first transparent electrodes 422 and 422′ that are arranged on a front surface and a rear surface of the first liquid crystal 421 to obliquely deviate from each other in a symmetric pattern based on the first liquid crystal 421 to apply driving voltage to the first liquid crystal 421, as illustrated in FIG. 4. The second liquid crystal 423 may be positioned in a pair of transparent electrodes 424 and 424′ that are arranged on a front surface and a rear surface of the second liquid crystal 423 based on the second liquid crystal 423 to apply driving voltage to the second liquid crystal 423. In this case, the first transparent electrodes 422 and 422′ may include a plurality of patterned indium tin oxides (ITOs) that is separated into at least two groups, respectively and the second transparent electrodes 424 and 424′ may a plate-like uniform ITO. The first liquid crystal 421 and the second liquid crystal 423 may operate in the normally white mode to transmit light when voltage is not applied and block light when voltage is applied. The first liquid crystal 421 and the second liquid crystal 423 may be provided between the glass substrates and may be the TN liquid crystal.

Meanwhile, the second panel 420 may further include a third polarizer 425 that polarizes the light transmitting the second liquid crystal liquid 423 in the same direction as the second polarizer 414 of the first panel 410. As one example, when the first polarizer 412 of the first panel 410 is a vertical polarizer and the second polarizer 414 is a horizontal polarizer, the third polarizer 425 may be the horizontal polarizer. In contrast, when the first polarizer 412 of the first panel 410 is the horizontal polarizer and the second polarizer 414 is the vertical polarizer, the third polarizer 425 may be the vertical polarizer.

The driving unit 430 may include a plurality of electrodes S1 to S6 for applying driving voltage to each of the transparent electrodes 422, 422′, 424, and 424′ included in the second panel. The driving unit 430 may control the driving voltage applied to the first liquid crystal 421 and the second liquid crystal 423 according to the position of the user and a watching distance.

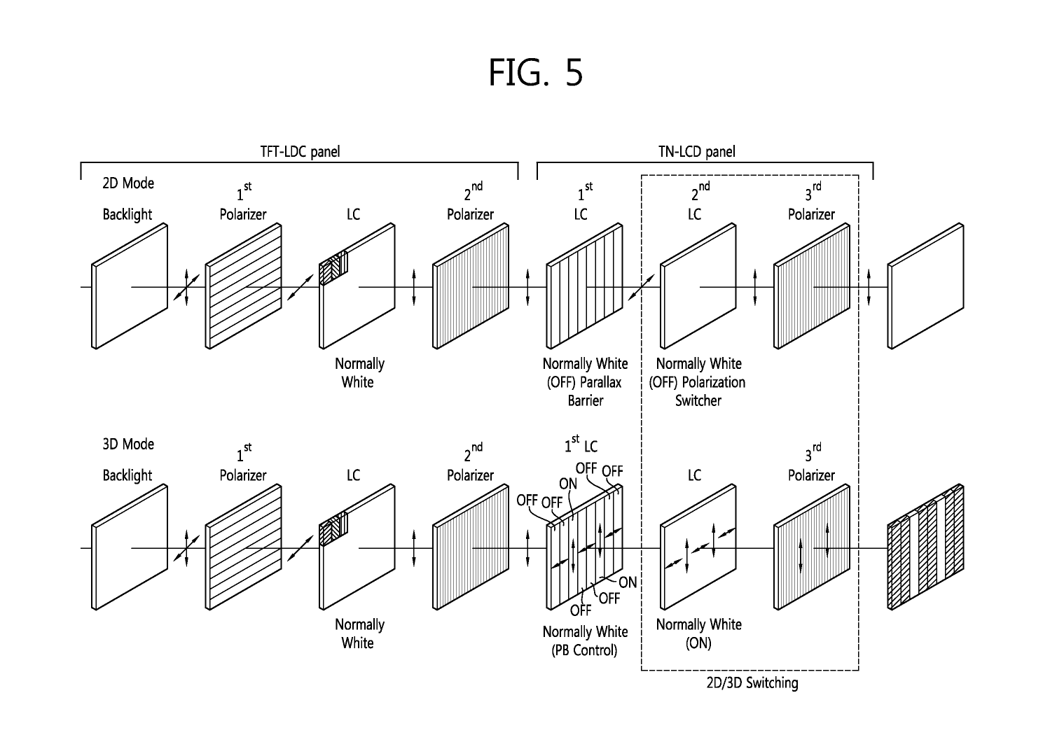

FIG. 5 is a diagram illustrating 2D mode and 3D mode operating ways of the parallax barrier based display apparatus according to the present invention.

In FIG. 5, for example, a case in which the first polarizer is the horizontal polarizer, the second polarizer is the vertical polarizer, and the third polarizer is the vertical polarizer is illustrated. However, the case is just exemplary and the first polarizer, the second polarizer, and the third polarizer of the display apparatus according to the present invention may be formed by the vertical polarizer, the horizontal polarizer, and the horizontal polarizer, respectively. Hereinafter, a case in which the display apparatus according to the present invention operates in the 2D mode and a case in which the display apparatus operates in the 3D mode will be described with reference to FIG. 5.

First, in the case where the display apparatus according to the present invention operates in the 2D mode, both voltages applied to the first liquid crystal layer and the second liquid crystal layer of the second panel (TN-LCD panel) are turned off to turn off a parallax barrier function and switch the polarization at 90°. In a normal case where voltage is not applied to both ends (OFF), polarization of light that passes through the liquid crystal is changed by 90° and in a case where voltage is applied to both ends (ON), the polarization of the light that passes through the liquid crystal is maintained as it is. Therefore, light vertically polarized and transmitted from the first panel (TFT-LCD panel) is horizontally polarized by the first liquid crystal layer, and vertically polarized again while transmitting the second liquid crystal layer. Finally the light is transmitted as it is through the third polarizer (vertical polarizer). As such, in the case where the display apparatus according to the present invention operates in the 2D mode, both liquid crystal layers of the second panel are turned off, and as a result, the vertical stripe does not occur and additional power consumption does not also occur.

Meanwhile, in the case where the display apparatus according to the present invention operates in the 3D mode, voltage is applied to only transparent electrodes at positions to transmit light among the transparent electrodes arranged on the first liquid crystal layer of the second panel and the polarization is maintained as it is by turning on the second liquid crystal layer in order to turn on the parallax barrier function. Accordingly, the light vertically polarized and transmitted from the first panel is vertically polarized while the polarization thereof is maintained as it is through parts applied with voltage in the liquid crystal layer and horizontally polarized through parts not applied with voltage. The polarization of the light that transmits the first liquid crystal layer is maintained as it is because the second liquid crystal is turned on. Therefore, finally, since only the light that is vertically polarized in the light that transmits the second liquid crystal layer may transmit the third polarizer and the horizontally polarized light is blocked, the light leakage phenomenon does not occur.

Consequently, in the display apparatus according to the present invention, polarization is appropriately switched by using the liquid crystal layer (second liquid crystal layer) and the polarizer (third polarizer) for polarization switching on the second panel depending on the 2D/3D mode to allow the liquid crystal (first liquid crystal) for forming the parallax barrier of the second panel to operate in the normally white mode in the 2D mode and operate in the normally black mode in the 3D mode. That is, in the case where the display apparatus according to the present invention operates in the 2D mode, the liquid crystal (second liquid crystal) for the polarization switching of the second panel is turned off to cause an effect of the normally white mode in which light is transmitted when voltage is not applied to the liquid crystal (first liquid crystal) for forming the parallax barrier and in the case where the display apparatus operates in the 3D mode, the liquid crystal for the polarization switching of the second panel is turned on to cause an effect of the normally black mode in which light transmitted in only the parts where the transparent electrodes applied with voltage are positioned in the liquid crystal for forming the parallax barrier. Table 1 below shows a scheme in which the display apparatus according to the present invention controls the first liquid crystal and the second liquid crystal in order to operate in the 2D/3D mode.

TABLE 1

| 2D/3D | Operation of TN liquid crystal | |
|---|---|---|
| mode | First liquid crystal | Second liquid crystal |
| 2D | OFF (voltage not applied) | OFF (voltage not applied: |
| mode | | 90° polarization) |
| 3D | Transparent electrode | ON (voltage applied: 0° |
| mode | control | polarization) |
| | (voltage applied to only | |
| | transparent electrodes to | |
| | be transmitted with light) | |

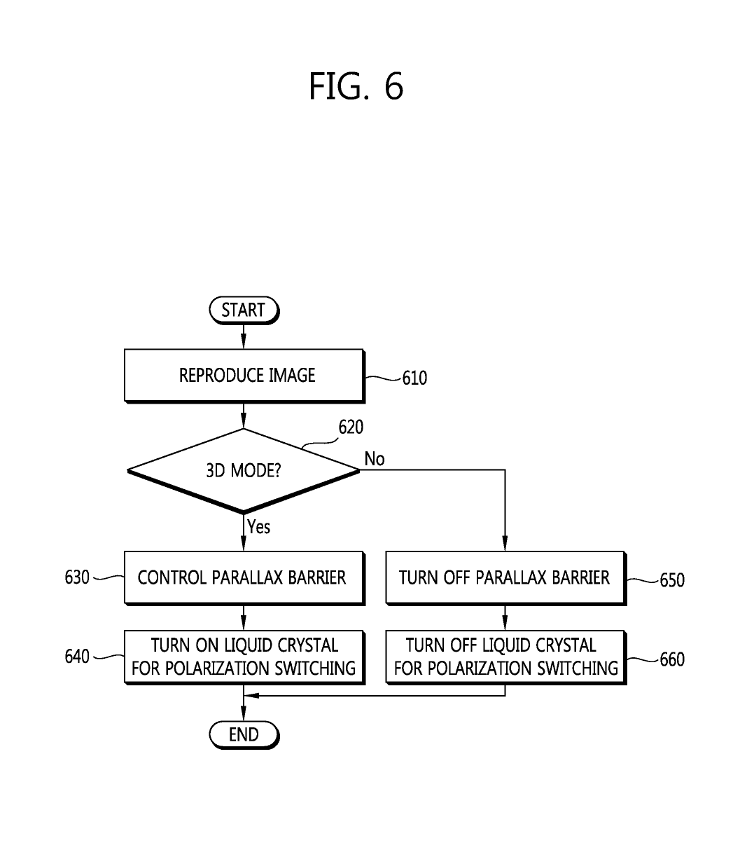

FIG. 6 is a flowchart illustrating a segmented parallax barrier based display method with 2D/3D mode switching according to an embodiment of the present invention.

The segmented parallax barrier based display method with 2D/3D mode switching according to the present invention may reproduce an image through the aforementioned first panel (610). In this case, the display apparatus according to the present invention judges an image display mode (620) to control a parallax barrier by applying driving voltage to a second panel positioned on a front surface of a first panel (630) and turn on a second liquid crystal for polarization switching (640) when the display apparatus is set to operate in a 3D mode (630). Herein, the second panel may include a first liquid crystal for forming the parallax barrier that blocks a part of the image reproduced by the first panel and the second liquid crystal for switching polarization of the light that transmits the first liquid crystal. The first liquid crystal and the second liquid crystal may operate in a normally white mode to transmit light when the driving voltage is not applied and block light when the driving voltage is applied.

As on example, when the display apparatus according to the present invention operates in the 3D mode, the driving voltage may be applied by using a pair of transparent electrodes that are arranged on a front surface and a rear surface of the first liquid crystal to obliquely deviate from each other in a symmetric pattern based on the first liquid crystal and the driving voltage may be applied by using a pair of second transparent electrodes that are arranged on a front surface and a rear surface of the second liquid crystal based on the second liquid crystal. Herein, the first transparent electrodes may include a plurality of patterned indium tin oxides (ITOs) that is separated into at least two groups and the second transparent electrodes may a plate-like uniform ITO. In this case, in the display apparatus according to the present invention, the driving voltage is applied to the first liquid crystal by using a patterned ITO determined depending on the position of a user and a watching distance in the plurality of patterned ITOs to selectively apply the driving voltage to only transparent electrodes to be transmitted with light.

Meanwhile, when the display apparatus according to the present invention is set to operate in the 2D mode, the driving voltage is prevented from being applied to the second panel to turn off the parallax barrier (650) and turn off the second liquid crystal for the polarization switching (660).

By such an operating scheme, the display apparatus according to the present invention may implement a segmented parallax barrier based display with 2D/3D switching by solving both occurrence of a vertical stripe in the 2D mode and a light leakage phenomenon in the 3D mode.

As set forth above, when a display apparatus operates in a 3D mode, transparent electrodes arranged in liquid crystals for forming a parallax barrier are controlled and driving voltage for polarization switching is applied to prevent a light leakage phenomenon from occurring and when the display apparatus operates in a 2D mode, the driving voltage is prevented from being applied to the liquid crystals for forming the parallax barrier and the liquid crystals for polarization switching to solve a problem in which a vertical stripe is viewed.

When the display apparatus operates in the 2D mode, voltage applied to a panel for reproducing a stereoscopic image can be turned off, and a result, additional power consumption does not occur at the time of reproducing a 2D image.

The spirit of the present invention has been exemplarily described as above, and various modifications and transforms can be made within the scope without departing from an essential characteristic of the present invention by those skilled in the art. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

While the invention has been shown and described with respect to the preferred embodiments, it will be understood by those skilled in the art that various changes and modifications may be made without departing from the spirit and scope of the invention as defined in the following claims.

What is claimed is:

1. A parallax barrier based display apparatus, comprising:
a first panel reproducing an image; and
a second panel positioned on a front surface of the first panel and including a first liquid crystal for forming a parallax barrier that blocks a part of the image reproduced by the first panel and a second liquid crystal for switching polarization of light that transmits the first liquid crystal.

2. The parallax barrier based display apparatus of claim 1, wherein:
the first liquid crystal and the second liquid crystal operate in a normally white mode to transmit light when voltage is not applied and block light when voltage is applied.

3. The parallax barrier based display apparatus of claim 1, wherein:
the first panel includes,
a backlight irradiating light;
a first polarizer polarizing the light irradiated from the backlight;
a liquid crystal transmitting the light polarized by the first polarizer; and
a second polarizer polarizing the light transmitting the liquid crystal.

4. The parallax barrier based display apparatus of claim 3, wherein:
the second panel further includes a third polarizer polarizing the light transmitting the second liquid crystal in the same direction as the second polarizer.

5. The parallax barrier based display apparatus of claim 1, wherein:
the second panel further includes,
a pair of first transparent electrodes arranged on a front surface and a rear surface of the first liquid crystal based on the first liquid crystal to obliquely deviate from each other in a symmetric pattern to apply driving voltage to the first liquid crystal; and
a pair of second transparent electrodes arranged on a front surface and a rear surface of the second liquid crystal based on the second liquid crystal to apply the driving voltage to the second liquid crystal.

6. The parallax barrier based display apparatus of claim 5, wherein:
the first transparent electrodes include a plurality of patterned indium tin oxides (ITOs) that is separated into at least two groups, and
the second transparent electrode is a plate-like ITO.

7. The parallax barrier based display apparatus of claim 1, further comprising:
a driving unit applying the driving voltage to the second panel in accordance with the position of a user and a watching distance.

8. A display panel, comprising:
a first liquid crystal for forming a parallax barrier that blocks a part of an image reproduced by a panel reproducing an image; and
a second liquid crystal for switching polarization of light that transmits the first liquid crystal.

9. The display panel of claim 8, wherein:
the first liquid crystal and the second liquid crystal are a twisted nematic (TN) liquid crystal that operates in a normally white mode to transmit light when voltage is not applied and block light when voltage is applied.

10. The display panel of claim 8, further comprising:
a polarizer polarizing light transmitting the second liquid crystal in the same direction as a polarizer provided on a front surface of the panel reproducing the image.

11. The display panel of claim 8, further comprising:
a pair of first transparent electrodes arranged on a front surface and a rear surface of the first liquid crystal based on the first liquid crystal to obliquely deviate from each other in a symmetric pattern to apply driving voltage to the first liquid crystal.

12. The display panel of claim 11, wherein:
the first transparent electrodes include a plurality of patterned indium tin oxides (ITOs) that is separated into at least two groups.

13. The display panel of claim 8, further comprising:
a pair of second transparent electrodes arranged on a front surface and a rear surface of the second liquid crystal based on the second liquid crystal to apply the driving voltage to the second liquid crystal.

14. The display panel of claim 13, wherein:
the second transparent electrode is a plate-like patterned indium tin oxide (ITO).

15. A method of displaying an image in a parallax barrier based display apparatus, comprising:
reproducing the image through a first panel; and
applying driving voltage to a second panel positioned on a front surface of the first panel when the display apparatus operates in a 3D mode,
wherein the second panel includes a first liquid crystal for forming a parallax barrier that blocks a part of the image reproduced by the first panel and a second liquid crystal for switching polarization of light that transmits the first liquid crystal.

16. The method of claim 15, wherein:
the first liquid crystal and the second liquid crystal operate in a normally white mode to transmit light when voltage is not applied and block light when voltage is applied.

17. The method of claim 15, wherein:
in the applying of the driving voltage to the second panel, the driving is applied to the first liquid crystal by using a pair of first transparent electrodes arranged on a front surface and a rear surface of the first liquid crystal based on the first liquid crystal to obliquely deviate from each other in a symmetric pattern and the driving voltage is applied to the second liquid crystal by using a pair of second transparent electrodes arranged on a front surface and a rear surface of the second liquid crystal based on the second liquid crystal to apply the driving voltage to the second liquid crystal.

18. The method of claim 17, wherein:
the first transparent electrodes include a plurality of patterned indium tin oxides (ITOs) that is separated into at least two groups, and
the second transparent electrode is a plate-like ITO.

19. The method of claim 18, wherein:
in the applying of the driving voltage to the first liquid crystal, the driving voltage is applied to the first liquid crystal by using a patterned ITO determined in accordance with the position of a user and a watching distance in the plurality of patterned ITOs.

20. The method of claim 15, further comprising:
after the reproducing,
preventing the driving voltage from being applied to the second panel when the display apparatus operates in a 2D mode.
